(19) United States
(12) Patent Application Publication
(10) Pub. No.: US 2010/0014395 A1
(43) Pub. Date: Jan. 21, 2010

(54) Information recording medium, information recording apparatus and method, and computer program

(76) Inventors: Kazuo Kuroda, Saitama (JP); Takeshi Koda, Saitama (JP); Takao Sawabe, Saitama (JP)

Correspondence Address: YOUNG & THOMPSON, 209 Madison Street, Suite 500, Alexandria, VA, 22314, US

(21) Appl. No.: 11/596,079

(22) PCT Filed: May 9, 2005
(86) PCT No.: PCT/JP05/08442

§ 371 Date: Jan. 4, 2007

(30) Foreign Application Priority Data
May 10, 2004 (JP) 2004-140248

(51) Int. Cl. G11B 20/00; G11B 7/24

(52) U.S. Cl. 369/47.15; 369/275.3

(57) ABSTRACT

An information recording medium such as DVD-R, DVD-RW or the like is provided with: an user information recording area in which user information can be recorded. The user information recording area has a pre-recorded area for preventing recording/reproduction of the user information, in an edge portion corresponding to a recording area portion in which reproduction control information for a read-only recording medium such as DVD-Video is recorded.

### TECHNICAL FIELD

The present invention relates to an information recording medium, such as a DVD, an information recording apparatus, such as a DVD recorder, an information recording method, and a computer program, for example.

### BACKGROUND ART

In an information recording medium, such as a CD (Compact Disc) and a DVD, a content protection function is incorporated. For example, a DVD format is constructed such that record contents can be reproduced only by a reproducing apparatus capable of performing decryption, by writing information about an encryption key in a lead-in area. Namely, it is designed such that each of a DVD video and DVD reproduction equipment has a “key” for performing the decryption, and only if the keys match, descrambling is performed, and video images can be normally reproduced.

However, lately, not only such a read-only DVD for recording contents (e.g. a DVD-Video), but also a DVD-R (Recordable) capable of writing only once, or a DVD-RW (Rewritable) capable of writing repeatedly are commercially available. Thus, if general disc data, including the encryption key information, is read from the DVD-Video or the like, as a RF signal, and it is hard-copied onto another recording medium, such as the DVD-R and the DVD-RW, the contents are illegally copied from the original DVD.

As a countermeasure against the illegal copying, a patent document 1 discloses a technology of forming embosses in an area out of the writable DVD where the encryption key information is recorded, in copying a DVD-Video or the like, such as the DVD-RW, to thereby make the area non-overwritable in advance. According to this method, the information is copied with the encryption key information lacked, so that it is extremely difficult to decrypt and normally reproduce the copied information.

Patent document 1: Japanese Patent Application Laid Open NO. 2000-331412

### DISCLOSURE OF INVENTION

### Subject to be Solved by the Invention

However, if the encryption performed on the DVD-Video or the like is broken and the contents are written into the DVD-RW or the like in the decrypted condition, there is such a technical problem that the reproduction can be performed, regardless of the encryption key information.

In order to solve the above-mentioned problem, it is therefore an object of the present invention to provide an information recording medium, an information recording apparatus, an information recording method, and a computer program, which enable the stronger protection of contents.

### Means for Solving the Subject

(Information Recording Medium)

Hereinafter, the information recording medium of the present invention will be explained.

The above object of the present invention can be achieved by an information recording medium provided with: a user information recording area in which user information can be recorded, the user information recording area having a pre-recorded area for preventing recording/reproduction of the user information, in an edge portion corresponding to a recording area portion in which reproduction control information for a read-only recording medium is recorded.

According to the information recording medium of the present invention, in the case where the record information of the read-only (or reproduce-only) recording medium is copied into the user information recording area, the area in which the reproduction control information for the record information is to be copied corresponds to the pre-recorded area. The “reproduction control information” herein means the control information for controlling the reproduction of content information, such as video information and audio information, of the read-only recording medium, for example, and it is information necessary for the reproduction of the content information. Thus, if the above copying is tried, the recording of the reproduction control information is forbidden or restricted in the pre-recorded area. The record information copied in this manner lacks the reproduction control information, so that the normal reproduction cannot be performed remarkably. Namely, the pre-recorded area functions to prevent the recording/reproduction with respect to the user information recording area. With regard to the information copied from the read-only recording medium, the reproduction is prevented even in the decrypted condition.

Moreover, in the user information recording area, a user can arbitrarily write the information into the portion other than the pre-recorded area, so that it is possible to ensure the standard value of a user data capacity. Moreover, if it is designed not to record the information into the pre-recorded area, the recording can be performed without greatly changing the normal writing method.

Moreover, by putting the pre-recorded area into the edge portion of the user information recording area, it is possible to combine the actually writable areas out of the user information recording area, into one physically continuous area. This is convenient in terms of data management and relatively facilitates the control at the time of recording/reproduction. Namely, when the information is recorded by a user, the presence of the pre-recorded area hardly hinders.

Therefore, on the information recording medium having such a pre-recorded area, it is possible to protect the contents recorded on the read-only recording medium while maintaining compatibility.

In one aspect of the information recording medium of the present invention, the information recording medium is further provided with: a lead-in area ahead of the user information recording area; and a lead-out area following the user information recording area, and the edge portion is a portion adjacent to the lead-in area or the lead-out area.

According to this aspect, the pre-recorded area is set on the start edge of the user information recording area (i.e. a portion adjacent to the lead-in area), or on the end edge of the user information recording area (i.e. a portion adjacent to the lead-out area). Putting the pre-recorded on the edge, as described above, is convenient in terms of data management and relatively facilitates the control at the time of recording/reproduction.

In another aspect of the information recording medium of the present invention, embossed pits are formed in advance in the pre-recorded area.

According to this aspect, the pre-recorded area is made non-overwritable by forming the embossed pits in advance in the area. Thus, it is possible to make the reproduction control information not be written onto the information recording medium, out of the record information copied from the read-only recording medium.

In another aspect of the information recording medium of the present invention, pre-pits obtained by irradiation of recording laser are formed in advance in the pre-recorded area.

According to this aspect, the pre-recorded area is made non-overwritable by forming the pre-pits in advance in the area. Thus, it is possible to make the reproduction control information not be written onto the information recording medium, out of the record information copied from the read-only recording medium. Incidentally, the pre-pits are written in a destructive writing method or an irreversible change recording method by heat or the like due to the irradiation of laser light.

In another aspect of the information recording medium of the present invention, the information recording medium is provided with a plurality of recoding layers in each of which recording areas constituting one portion of the user information recording area are formed and which are mutually laminated, a start edge portion of said user information recording area is disposed in one recording layer so as to face an end edge portion of said user information recording area in another recording layer, and the pre-recorded area is set in the end edge portion.

According to this aspect, firstly, the user information recording area is disposed over the plurality of recording layers, and the start edge portion and the end edge portion thereof are disposed in the areas opposed to each other in the recording layers which are mutually different. Such a structure can be realized in an “opposite track path type” which is adopted if the information is of a multilayer type and in which recording track paths are directed in the opposite direction between the adjacent two layers.

The reading in the user information recording area is started from the start edge portion, and if the information copied from the read-only recording medium is read, it is necessary to read the reproduction control information. At this time, the reproduction is performed after jumping from the start edge portion of the user information recording area to the edge end portion where the reproduction control information is supposed to be recorded, i.e. the pre-recorded area. The start edge portion and the end edge portion are opposed to each other in the lamination direction of the recording layers, so that it is hardly necessary or not necessary at all to change the irradiation position of the laser light in a direction of layer surface, and it takes a short time to search during this time.

In another aspect of the information recording medium of the present invention, reproduction restriction information which functions to prevent reproduction of information which is recorded in the user information recording area, is written in the pre-recorded area.

According to this aspect, in reproducing the information copied from the read-only recording medium, in order to use the reproduction control information out of the information, the reading is performed from the area in which the reproduction control information is supposed to be recorded, i.e. from the pre-recording area. At this time, instead of the reproduction control information, the reproduction restriction information is read, and the reproduction from the user information recording area is prevented on the basis of the reproduction restriction information.

Thus, it is possible to prevent the reproduction of the information copied from the read-only recording medium, more certainly.

In an aspect in which the reproduction restriction information is written in the pre-recorded area, the reproduction restriction information may include control information for making the information which is recorded in a predetermined area being loop-reproduced.

In this case, once the reading is performed in the pre-recorded area, the loop reproduction is performed in the predetermined area, so that it is impossible to continue the reproduction after jumping to another area in the user information recording area.

In another aspect of the information recording medium of the present invention, reproduction end information for ending reproduction of information which is recorded in the user information recording area by jumping to a reproduction end area defined in advance, is written in the pre-recorded area.

According to this aspect, in reproducing the information copied from the read-only recording medium, after the reading is performed in the pre-recorded area in order to use the reproduction control information, the reproduction from the user information recording area performed by a user is ended, by jumping to the reproduction end area defined in advance, such as the lead-out area, on the basis of the reproduction end information.

Thus, it is possible to prevent the reproduction of the information copied from the read-only recording medium, more certainly.

In another aspect of the information recording medium of the present invention, unreproducibility-announcing information for displaying a message indicating that reproduction of information which is recorded in the user information recording area is forbidden, is written in the pre-recorded area.

According to this aspect, in reproducing the information copied from the read-only recording medium, after the reading is performed in the pre-recorded area in order to use the reproduction control information, the reproduction from the user information recording area is ended, as described above, but at the same time, the message indicating that the reproduction of the information which is recorded in the user information recording area is forbidden is displayed on the basis of the unreproducibility-announcing information.

Thus, it is possible to inform a user that the ending of the reproduction is not caused by the failure of the reproducing apparatus but caused by the fact that a reproduction target is the contents to be protected.

In another aspect of the information recording medium of the present invention, scan-forbidding information indicating that an instruction to scan information which is recorded in the user information recording area is set to be invalid in a reproduction period of the pre-recorded area and before the reproduction period, is written in at least one of the pre-recorded area and an area which is outside the user information recording area.

According to this aspect, in reproducing the information copied from the read-only recording medium, the instruction to scan the user information recording area in the reproduction period of the pre-recorded area and before the reproduction period is made invalid on the basis of the scan-forbidding information. Namely, if the instruction to scan is inputted to the reproducing apparatus in the above-mentioned reproduction period and the scanning is started from a reading position at the present time point, there is a possibility that the copied information is reproduced even partially. However, here, since the scan-forbidding information is written in advance so as to read it in the above-mentioned period or before that, such a situation is prevented.

Thus, it is possible to prevent the reproduction of the information copied from the read-only recording medium, more certainly.

In another aspect of the information recording medium of the present invention, a start address and an end address of the pre-recorded area are fixed.

According to this aspect, the start address and the end address of the pre-recorded area are recorded on the information recording medium, as one portion of the fixed control information. Or the start address and the end address of the pre-recorded area are standardized. Thus, it is possible to know in advance the position and the range of the pre-recorded area, so that it is possible to prevent such a situation that the information is mistakenly written up to the pre-recorded area in the normal information writing.

Moreover, it is possible to ensure the protection of the contents on the basis of the above-mentioned principle, by setting the recording position and range of the reproduction control information of the contents to be recorded onto the read-only recording medium, on the basis of the address information of the pre-recorded area.

(Information Recording Apparatus)

The above object of the present invention can be also achieved by an information recording apparatus for recording information which is to be recorded onto an information recording medium provided with: a user information recording area in which user information can be recorded, the user information recording area having a pre-recorded area for preventing recording/reproduction of the user information, in an edge portion corresponding to a recording area portion in which reproduction control information for a read-only recording medium is recorded, the information recording apparatus provided with: a writing device capable of writing the information to be recorded, into the user information recording area; and a controlling device for controlling the writing device to write the information to be recorded, into an area other than the pre-recorded area out of the user information recording area, on the basis of address information in the pre-recorded area.

According to the information recording apparatus of the present invention, it is possible to properly record the information onto the information recording medium of the present invention.

In the user information recording area, the area other than the pre-recorded area is a substantially recordable area, i.e. the area that a user can arbitrarily write information. If the information is recorded onto the information recording medium of the present invention, it is necessary not to write the information into the pre-recorded area. Thus, when the information is written by the writing device, the writing device is controlled to write the information only into the area other than the pre-recorded area, out of the user information recording area, under the control of the controlling device based on the address information of the pre-recorded area. At this time, the address information of the pre-recorded area used, may be stored in advance in the controlling device if it is known, or may be read from the information recording medium.

Incidentally, even the information recording apparatus of the present invention can adopt aspects corresponding to the various aspects of the above-mentioned information recording medium of the present invention, as occasion demands.

(Information Recording Method)

The above object of the present invention can be also achieved by an information recording method of recording information which is to be recorded onto an information recording medium provided with: a user information recording area in which user information can be recorded, the user information recording area having a pre-recorded area for preventing recording/reproduction of the user information, in an edge portion corresponding to a recording area portion in which reproduction control information for a read-only recording medium is recorded, the information recording method provided with: a writing process of writing the information to be recorded, into an area other than the pre-recorded area out of the user information recording area, on the basis of address information in the pre-recorded area.

The information recording method of the present invention achieves the same operation and effect as those of the above-mentioned information recording apparatus of the present invention. Incidentally, the present invention can adopt the same aspects as the various aspects of the above-mentioned information recording apparatus of the present invention, as occasion demands.

(Computer Program)

The above object of the present invention can be also achieved by a computer program for controlling a computer provided in the above-mentioned information recording apparatus of the present invention (including its various aspects), the computer program making the computer function as at least one portion of the controlling device and the writing device.

According to the computer program of the present invention, the above-mentioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned information recording apparatus of the present invention, the computer program of the present invention can also adopt various aspects.

The above object of the present invention can be also achieved by a computer program product in a computer-readable medium for tangibly embodying a program of instructions executable by a computer provided in the above-mentioned information recording apparatus of the present invention (including its various aspects), to make the computer function as at least one portion of the controlling device and the writing device.

According to the computer program product of the present invention, at least one portion of the controlling device and the writing device of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the controlling device and the writing device of the present invention described above.

As explained above, according to the information recording medium of the present invention, it has the pre-recorded area in the edge portion of the user information recording area, so that it is possible to protect the contents recorded on the read-only recording medium while maintaining compatibility.

According to the information recording apparatus of the present invention, it is provided with: the writing device; and the controlling device, so that it is possible to properly record the information onto the information recording medium of the present invention.

Moreover, according to the information recording method of the present invention, it is provided with the writing process, so that it is possible to properly record the information onto the information recording medium of the present invention.

Moreover, according to the computer program of the present invention, it makes a computer function as the information recording apparatus of the present invention, so that it is possible to properly record the information onto the information recording medium of the present invention.

These effects and other advantages of the present invention will become more apparent from the following embodiments.

### BRIEF DESCRIPTION OF DRAWINGS

FIG. 1 are (a) a substantial plan view showing the basic structure of an optical disc in a first embodiment of the information recording medium of the present invention, and (b) an outline cross sectional view of the optical disc and a schematic conceptual view showing a recording area structure in the radial direction in association with the cross sectional view.

FIG. 2 is a conceptual structure diagram showing the layout of a data area of the optical disc in the first embodiment of the present invention and a conceptual structure diagram showing the layout of a data area of a ROM disc corresponding to the optical disc.

FIG. 3 is a conceptual structure diagram showing the data structure of the optical disc in the first embodiment of the present invention and a conceptual structure diagram showing the data structure of the ROM disc corresponding to the optical disc.

FIG. 4 is a conceptual structure diagram showing the data reading procedure of the optical disc in the first embodiment of the present invention and a conceptual structure diagram showing the data reading procedure of the ROM disc corresponding to the optical disc.

FIG. 5 is a flowchart showing the reproduction operation procedure of normal contents on the ROM disc in the first embodiment of the present invention.

FIG. 6 is a flowchart showing the reproduction operation procedure of contents copied on the optical disc in the first embodiment of the present invention.

FIG. 7 is a block diagram showing the structure of a recording/reproducing apparatus as an information recording apparatus in the first embodiment of the present invention.

FIG. 8 is a flowchart showing a recording operation procedure with respect to the optical disc, performed by the recording/reproducing apparatus in the first embodiment of the present invention.

FIG. 9 is a conceptual structure diagram showing the layout of the data area of an optical disc in a second embodiment of the present invention and showing the layout of a data area of a ROM disc corresponding to the optical disc.

### DESCRIPTION OF REFERENCE CODES

100 . . . optical disc, 200 . . . ROM disc, 101, 201 . . . lead-in area, 102, 202 . . . data area, 103, 203 . . . lead-out area, 104, 204 . . . middle area, 105 . . . pre-recorded area, 106 . . . transparent substrate, PB . . . video reproduction control information, FS . . . file system

### BEST MODE FOR CARRYING OUT THE INVENTION

Hereinafter, the best mode for carrying out the present invention will be explained in each embodiment in order, with reference to the drawings.

### First Embodiment

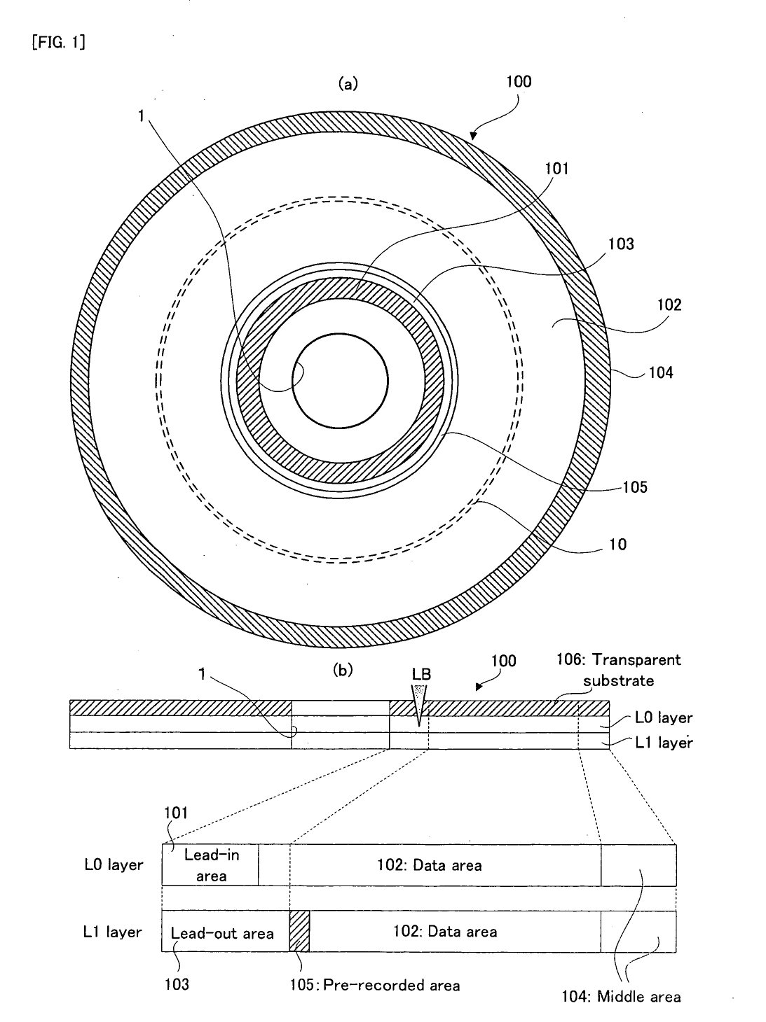

The first embodiment of the present invention will be explained with reference to FIG. 1 to FIG. 6.

(Structure of Optical Disc)

Firstly, with reference to FIG. 1, the basic structure of an optical disc in the first embodiment of the present invention will be explained. FIG. 1(a) shows the basic structure of the optical disc having a plurality of recording areas in the first embodiment of the information recording medium of the present invention, and FIG. 1(b) shows the outline cross section of the optical disc and a recording area structure in the radial direction in association with the cross section.

In FIG. 1(a) and FIG. 1(b), an optical disc 100 is an information recording medium. on which recording can be performed only once or repeatedly, such as a DVD-R and a DVD-RW, for example. For example, its disc main body with a diameter of about 12 cm, is constructed from an L0 layer and an L1 layer, which are recording layers, laminated on a transparent substrate 106. On each recording surface of the L0 layer and the L1 layer, a track or tracks 10, such as a groove track and a land track, are placed, spirally or concentrically, centered on a center hole 1, for example. In the center, a user data area 102, as one example of the “user information recording area” of the present invention, is set to be sandwiched between buffer areas on its inner and outer circumferential sides. The buffer area is an area to prevent a recording or reproduction position from deviating to the outside of the substrate. Here, the buffer areas indicate a lead-in area 101, a lead-out area 103, and a middle area 104. Namely, the recording surface of the L0 layer is divided into the lead-in area 101, the user data area 102, and the middle area 104, from the inner circumferential side. Moreover, the recording surface of the L1 layer is divided into the lead-out area 103, the user data area 102, and the middle area 104, from the inner circumferential side. In each of the areas, the data is divided by each sector to which an address is assigned, and 1 ECC (Error Correcting Code) block is constructed from each 16 sectors, wherein the 1 ECC block is a unit of error-correction process.

On such a two-layer type optical disc 100, depending on which layer of the L0 layer or the L1 layer has the focus position of laser light LB, irradiated from the transparent substrate 106 side, it is possible to select one of the recording layers and perform the recording/reproduction. Moreover, as the recording or reproduction procedure of the two-layer type optical disc 100, an opposite track path type, in which the recording or reproduction is performed in a direction from the inner to the outer circumferential side (e.g. from the lead-in area 101 to the middle area 104) of the L0 layer and further in a direction from the outer to the inner circumferential side (e.g. from the middle area 104 to the lead-out area 103) of the L1 layer, is adopted. In the opposite track path type, when the scanning of the L0 layer is ended and the scanning of the L1 layer is started, there is no need to displace an optical pickup, located on the outermost circumference of the optical disc, to the innermost circumference, and it is only necessary to change a focal distance from the L0 layer to the L1 layer. Thus, the opposite track path type has an advantage that a changing time from the L0 layer to the L1 layer is shorter than a parallel track path type.

The lead-in area 101 is an area firstly accessed at the time of recording or reproduction of the optical disc 100. Inside thereof, there are set: a reference code area in which the encryption key information used for scrambling is recorded; and a control data area in which various types of control information is recorded.

The user data area 102 is an area to record therein data corresponding to the contents to be recorded. The data to be recorded includes image data, audio data, computer-readable program data, or the like.

Incidentally, in the embodiment, a pre-recorded area 105 is set in a range adjacent to the lead-out area 103, out of the user data area 102. The details will be described later, but the pre-recorded area 105 is formed in advance, as an area for preventing the recording/reproduction of user data with respect to the pre-recorded area, by using embossed pits if the optical disc 100 is a DVD-RW, and by using pre-pits obtained by the irradiation of the recording laser if it is a DVD-R.

The lead-out area 103 is an area following the end edge of the user data area 102 in the recording or reproduction, and there is recorded information indicating the lead-out area 103. Moreover, the middle area 104 has a basic function for preventing the recording or reproduction position for the L0 layer and the L1 layer from deviating to the outside of the substrate. The middle area 104 functions as a so-called “jump buffer area” for preventing the recording or reproduction position from deviating to the outside of the substrate in layer jump. Specifically, in the L0 layer, the information to be recorded, such as the contents, is recorded, and subsequently, a predetermined amount of buffer data is recorded into one portion of the middle area 104 of the L0 layer. Then, after layer jump from the middle area 104 of the L0 layer to the L1 layer, a predetermined amount of buffer data is written as one portion of the middle area 104 of the L1 layer, and subsequently, the information to be recorded is recorded in the L1 layer.

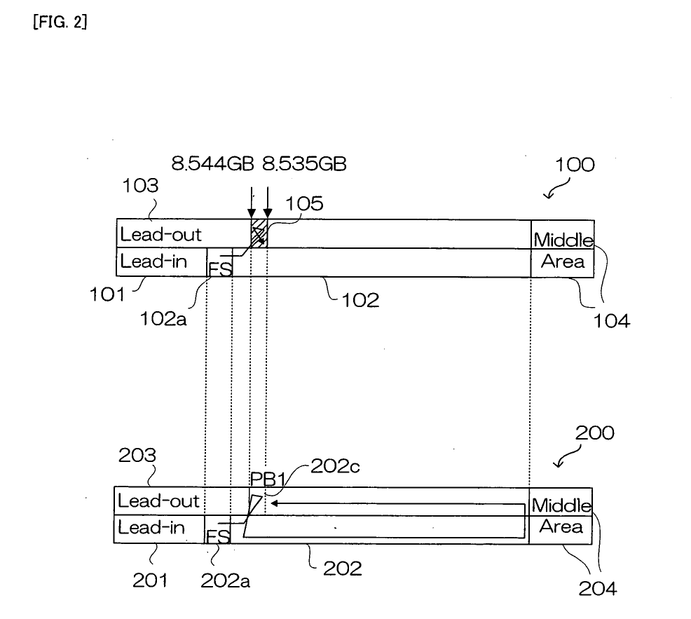

Next, with reference to FIG. 2 to FIG. 6, the structure and the operation of the characterizing portion of the optical disc 100 will be explained.

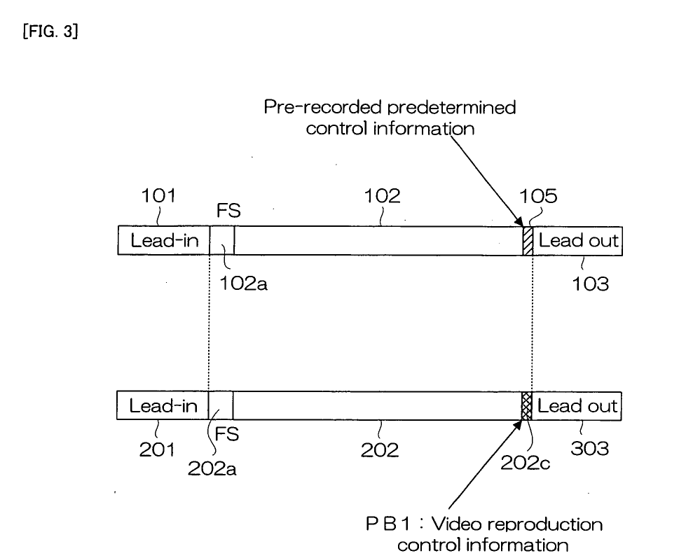

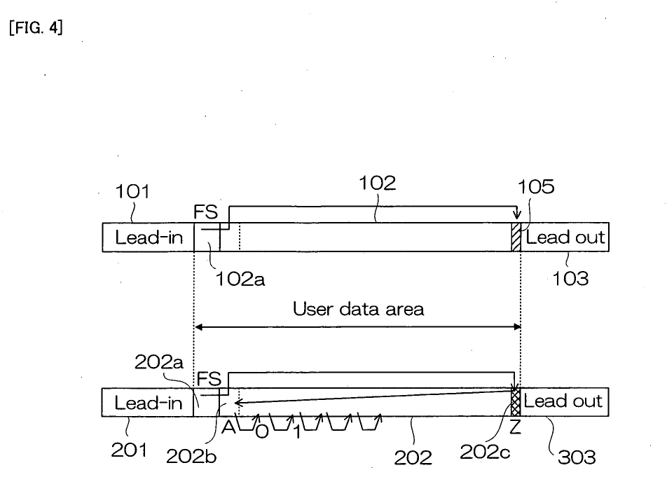

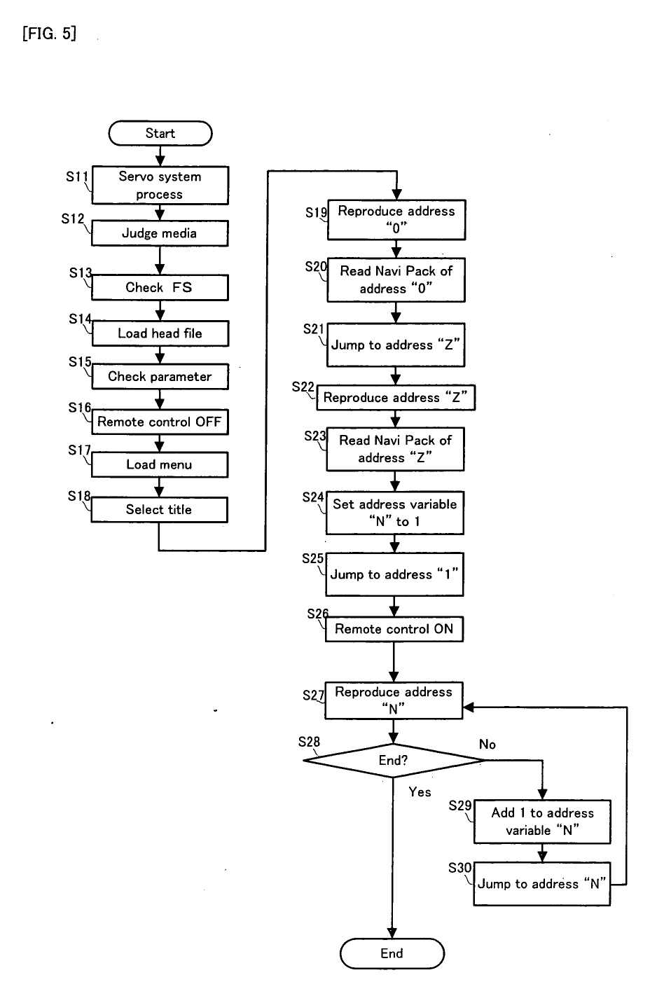

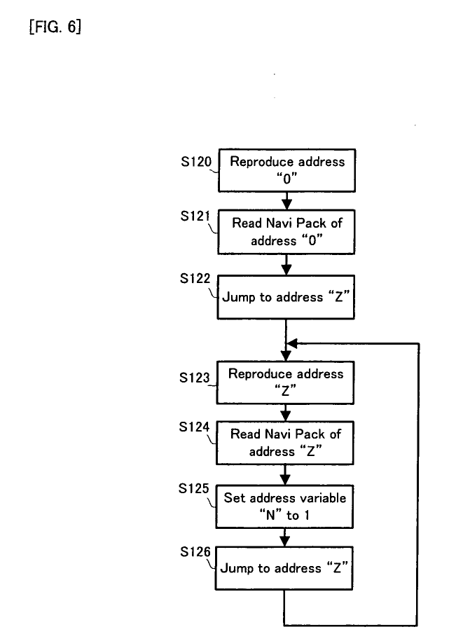

In all FIG. 2 to FIG. 4, the optical disc 100 in the embodiment is shown on the upper side, and a ROM disc 200 is shown on the lower side, corresponding to each other. FIG. 2 shows the layout of the data area of each recording medium. Incidentally, the arrangement of the recording layers in FIG. 2 is opposite to that in FIG. 1(b) in the vertical direction. FIG. 3 shows the data structure of each recording medium, and FIG. 4 shows a data reading procedure. FIG. 5 shows the reproduction operation procedure of normal contents, performed by the ROM disc 200, and FIG. 6 shows the reproduction operation procedure of the contents copied on the optical disc 100.

As shown in FIG. 2, the optical disc 100 is designed to have substantially the same basic structure as that of the reproduce-only (or read-only) ROM (Read Only Memory) disc 200, so that compatibility is maintained. Namely, the recording area of the ROM disc 200 is divided into a lead-in area 201, a user data area 202, a lead-out area 203, and a middle area 204, which correspond to the lead-in area 101, the user data area 102, the lead-out area 103, and the middle area 104 of the optical disc, respectively.

However, on the ROM disc 200, the content data is recorded in advance in the user data area 202. Then, along with the recording of actual data of the contents, a file system FS is written into a head area 202a of the user data area 202, and video reproduction control information PB1 for each content is written into a tail area 202c of the user data area 202.

The content data in the user data area 202 is written by using a relative address, and the address information is included in the video reproduction control information PB1. Moreover, storage information about where various data is recorded, is managed in the file system FS. Incidentally, here, the ROM disc 200 is one example of the “read-only recording medium” of the present invention, and the video reproduction control information PB1 is one example of the “reproduction control information” of the present invention.

In contrast, in the embodiment, the pre-recorded area 105 is set in an area of the optical disc 100, corresponding to the area 202c where the video reproduction control information PB1 is recorded, on the ROM disc 200. Here, the pre-recorded area 105 is set in an area between the position of 8.535 GBytes and the position of 8.544 GBytes in the optical disc 100, as shown in FIG. 2. Thus, the user data area 102 has a size rounded to 8.54 GBytes, i.e. a size based on the standard.

Thus, if the content data of the ROM disc 200 is dead-copied onto the optical disc 100, the copy data of the user data area 202 is written from an area 102a, with the file system FS as the head. However, the substantial recording area of the user data area 102 is placed until just before the pre-recorded area 105, and it is not physically rewritable after the pre-recorded area 105. In other words, even if the hard copying or dead copying is performed, the contents of the ROM disc 200 are recorded onto the optical disc 100 only in such a condition that the data in the area 202c corresponding to the pre-recorded area 105, i.e. the video reproduction control information PB1, falls off in its entirety. Incidentally, in the embodiment, in the pre-recorded area 105, there is written the control information for loop-reproducing the information in the pre-recorded area 105.

From the data structure shown in FIG. 3, a correspondence relationship between the recording area 202c of the video reproduction control information PB1 and the pre-recorded area 105 will be seen at a glance.

(Reproduction on Optical Disc)

By adopting such a structure, the reading operation on the optical disc 100 will be performed as follows, if the contents are copied from the ROM disc 200.

Firstly, the normal reproduction of the ROM disc 200 is performed in a procedure shown in FIG. 4 and FIG. 5, on a reproducing apparatus. Incidentally, here, it is assumed that the ROM disc 200 is a DVD-Video, and that the reproducing apparatus has a DVD-reproducible (or DVD-readable) structure. The reproducing apparatus may be constructed in the same manner as usual, and the illustration and the explanation thereof will be omitted. Incidentally, as the reproducing apparatus, it is also possible to apply a recording/reproducing apparatus capable of supporting the ROM disc 200.

On the reproducing apparatus, for example, the insertion of the ROM disc 200 triggers performing a servo system process, such as focus positioning of the optical pickup, and the ROM disc 200 is loaded (step S11). Then, various information is read from the lead-in area 201 out of the ROM disc 200, and on the basis of that, the media type of the inserted disc is judged (step S12). Here, it is known to be a DVD, so that subsequently, the file system FS is read from the area 202a and checked (step S13). At this time, the head address “A” of the contents is obtained.

If it becomes clear that the format of the inserted disc is of a DVD-Video type by using the file system FS, the file of a data area 202b is loaded, wherein the data area 202b is the head of the user data area 202 shown in FIG. 4 and specified by the address “A” (step S14). After a parameter stored in this file is checked (step S15) and the OFF state of remote control described later is determined (step S16), a content menu is further loaded from the head file (step S17) and displayed on the reproducing apparatus. Then, from title selection and instruction performed by a user (step S18), the contents to be reproduced on the reproducing apparatus are determined.

Then, the data is reproduced from the head address “0” of the contents to be reproduced (step S19), and a Navi Pack corresponding to the address “0” is read (step S20). Then, in accordance with the read navigation information, jumping is performed to an area represented by an address “Z” out of the user data area 202 (step S21), and the data, i.e. the video reproduction control information PB1, is reproduced from the area 202c specified by the address “Z” (step S22).

Then, a Navi Pack corresponding to the address “Z” is read (step S23). After a variable N, representing the address of the data which is a reproduction target, is set to 1 (step S24), jumping is performed to an area represented by the address “N (i.e. 1)” out of the user data area 202 (step S25). At this time point, the remote control of the variable N is set to be in ON state (step S26), and after that, the data within the specified contents is sequentially reproduced, from the address “1” next to the address “0”. Namely, the data is reproduced from the address “N” (step S27), and if the reproduction of the data within the contents is not finished yet (step S28: No), 1 is added to the variable N (step S29). Then, jumping is performed to the area represented by the address “N” (step S30), and until the data reproduction of all the contents is ended (the step S28: Yes), the reproduction of the data from the address “N” is repeated. Incidentally, as is seen from the above-mentioned operation, the address (0, 1, . . . , N) of the content data is a relative address.

As opposed to this, as shown in FIG. 2 or FIG. 3, the reproduction on the optical disc 100 onto which the content data of the ROM disc 200 is dead-copied, is performed on the reproducing apparatus in a procedure shown in FIG. 4 and FIG. 6.

The operation procedure on the reproducing apparatus in this case is the same as at the time of reproduction of the above-mentioned ROM disc 200 until the contents to be reproduced are selected and specified from the optical disc 100.

Even afterward, in the same manner, the data is reproduced from the head address “0” of the contents to be reproduced (step S120), and the Navi Pack corresponding to the address “0” is read (step S121). Then, in accordance with the read navigation information, jumping is performed to the area represented by the address “Z” out of the user data area 202 (step S122), and the data is reproduced from the address “Z” (step S123).

The address “Z”, as shown in FIG. 4, indicates the pre-recorded area 105. Thus, instead of the video reproduction control information PB1, the data written in advance in the pre-recorded area 105 is read. If it is the control information as one example of the “reproduction control information” of the present invention, for example, the reproducing apparatus performs a subsequent operation in accordance with the information.

Here, the optical disc 100 is searched in the opposite track path type (refer to FIG. 2), so that it is hardly necessary or not necessary at all to change the irradiation position of the laser light in a direction of layer surface, in jumping to the area represented by the address “Z”, and a searching time is short.

In the pre-recorded area 105, as described above, the control information for loop-reproducing the information in the pre-recorded area 105 is written, and an infinite loop is intentionally formed in the pre-recorded area 105. Namely, if the Navi Pack corresponding to the address “Z” is read (step S124), after a flag variable N, representing the address of the data which is a reproduction target, is set to 1 (step S125), jumping is performed to the area represented by the address “Z” again (step S126). After that, a series of steps is repeated until forced termination. During the time, a meaningless same screen is displayed on the reproducing apparatus, for example.

As a result, in this case, it is prevented to reproduce the contents, which are actually meaningful, from the optical disc 100. Moreover, the embodiment is designed such that the video reproduction control information PB1 included in the content data itself is lacked if the dead copying is performed from the ROM disc 200 to the optical disc 100, so that it is difficult to logically normally reproduce all the contents. In the actual sequence, the normal operation becomes difficult after the reading of the video reproduction control information PB1. This is performed regardless of the operation of encrypting the dead-copied contents, so that it is possible to protect the contents, more certainly.

As described above, according to the optical disc 100, it is prevented to watch the contents illegally copied, and furthermore, it contributes the prevention of illegal copying, which enables the stronger protection of the contents. Moreover, such an effect is achieved just by providing the pre-recorded area 105.

Moreover, the embodiment is designed such that the infinite loop program data is written in advance in the pre-recorded area 105, instead of the video reproduction control information PB1, so that if the contents are dead-copied from the ROM disc 200, the actual data of the contents cannot be accessed when the content sequence of the DVD-Video uses the pre-recorded area 105. Thus, it is possible to prevent the reproduction of the contents after the copying, more certainly.

Incidentally, the position of the loop is not necessarily located in the pre-recorded area 105. For example, the loop may be performed after jumping to another appropriate area from the pre-recorded area 105, for example.

Alternatively, the control information which makes jumping to the lead-out area 103 may be written in the pre-recorded area 105 in advance, and the reproduction may be ended when the content sequence of the DVD-Video uses the pre-recorded area 105.

Moreover, so as to display a message, such as “this data cannot be reproduced”, for example, in reading the pre-recorded area 105, the control information indicating that may be written in advance in the pre-recorded area 105.

The information to be written into the pre-recorded area 105 may be of any type, and various kinds are possible, in addition to the above-mentioned examples. However, in order to make the content protection more certain, it is preferably the control information which functions to prevent the reproduction of the dead-copied contents, or the like.

Such control information may be written not only in the pre-recorded area 105 but also in the other areas, such as the lead-in area 101. For example, if a key for the remote control or the like is received on the period between the reading of the lead-in area 101 and the reading of the pre-recorded area 105, the user data area 102 may be scanned to thereby reproduce the contents, in some cases. Thus, it is better to set the control information for making a reproduction instruction invalid, such as setting a flag in the area and not receiving the key during the reading operation.

Moreover, the optical disc 100 and the ROM disc 200 are of the two-layer type, but adopt the opposite method, so that the recording/reproduction is performed as shown by the arrow in FIG. 2. Thus, according to the optical disc 100 in the embodiment, a physical distance between the head area of the user data area 102 and the pre-recorded area 105 is shorter than the case of a single layer type or the parallel method. Thus, there is such an advantage that it takes a shorter time to search the pre-recorded area 105.

Incidentally, the position of the pre-recorded area 105 on the optical disc 100 is determined from a relationship with the recording position of the reproduction control information in the recording medium which is a copy protection target, such as the ROM disc 200. Thus, the structure of the both media, the recording/reproducing method, the layout of each area, or the like are preferably symmetric, physically or logically (refer to FIG. 2 and FIG. 3), and the compatibility can be maintained. Here, the pre-recorded area 105 is set as the end edge of the user data area 202. This is because in the normal read-only recording medium, the control information is mostly recorded on the end edge side, in terms of data management, as in the ROM disc 200. By putting the pre-recorded area 105 onto the end edge of the user data area 202 as much as possible, it is possible to use the inner recording area easily, which is convenient.

By the way, if the optical disc 100 is a DVD-R or a DVD-R/W, the standard of its capacity is 8.54 GBytes, but in fact, it can be said that even 8.544 GBytes and 8.535 GBytes are within the standard (if the recording layer is a single layer, 4.70 GBytes is a standard value, and 4.704 GBytes and 4.695 Gbytes are within the standard). Namely, there is an allowable value of 9 MBytes. Thus, if the range of the pre-recorded area 105 of the optical disc 100 is set to the position of 8.535 GBytes or more and the position of 8.544 GBytes or less, and if the control information is recorded on the ROM disc 200, which is the DVD-Video, for example, so as to access the above data range, then, the user recording capacity of the optical disc 100 is 8.54 GBytes, and the accessing is possible with the 8.54 GByte DVD-Video data. If the recording layer is a single layer, the pre-recorded area may be set to be within the margin of the standard capacity, in the same manner.

Therefore, in the optical disc 100, it is possible to achieve the content protection function while maintaining the compatibility.

Incidentally, the position and the range of the pre-recorded area 105 of the optical disc 100 are linked with the recording position and the recording range of the video reproduction control information PB of the ROM disc 200. Namely, if the recording medium on which the contents which are a protection target are recorded (which is the ROM disc 200 here) is newly prepared, the position and the range of the video reproduction control information in the contents are set on the basis of the position and the range of the pre-recorded area 105 set in advance on the optical disc 100. Alternatively, if there is already the recording medium on which the contents which are a protection target are recorded (which is the ROM disc 200 here), or if the recording area where the video reproduction control information is recorded is known in advance, the position and the range of the pre-recorded area 105 of the optical disc 100 may be set on the basis of the position and the range of the area 202c where the video reproduction control information is recorded. As described above, the optical disc 100 in the embodiment can achieve the above-mentioned effect if it has the correspondence relationship with the ROM disc 200.

(Recording on Optical Disc)

So far, the aspect about the illegal copying of the optical disc 100 has been explained. The optical disc 100, however, is originally a recording medium on which a user arbitrarily writes the data, and it is desired to correctly perform the recording/reproduction with regard to proper copying, aside from the illegal copying. In this regard, in the optical disc 100, there is no special action taken against the recording surface, except for the provision of the pre-recorded area 105, so that it is possible to perform such data recording/reproduction, in the same manner as usual.

However, the optical disc 100 has a narrower virtually writable area, by the amount of the pre-recorded area 105, than that of the ROM disc 200. Thus, if the address of the end edge of the writable area is defined in a Last Recordable Address, in order not to write the area following the area of the address of the end edge of the writable area any more, and if the address information is recorded in advance in the lead-in area 101, for example, it is ensured that the normal writing is performed. Or if the address of the end edge of the writable area is fixed as a standard value, it is ensured that the normal writing is performed. Incidentally, the start address and the end address of the writable area, i.e. the substantial user data area, can be obtained on the basis of the start address and the end address of the pre-recorded area 105.

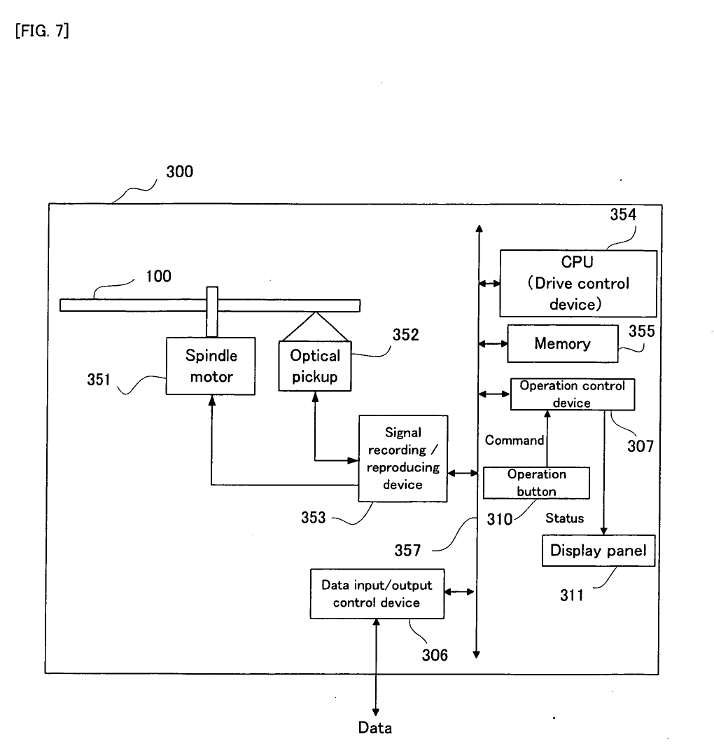

Hereinafter, the specific method of recording information onto the optical disc 100 will be further explained with reference to FIG. 7. FIG. 7 shows the structure of a recording/reproducing apparatus.

(Structure of Information Recording Apparatus)

A recording/reproducing apparatus 300 in FIG. 7 has a function of recording information onto the optical disc 100 and of reading the information recorded on the optical disc 100 as one example of the “information recording apparatus” of the present invention, on the basis of the “information recording method” of the present invention, under the control of a CPU (Central Processing Unit). The recording/reproducing apparatus 300 is provided with: a spindle motor 351; an optical pickup 352; a signal recording/reproducing device 353; a CPU (drive control device) 354; a memory 355; a data input/output control device 306; an operation control device 307; an operation button 310; a display panel 311; and a bus 357. Out of them, the spindle motor 351, the optical pickup 352, the signal recording/reproducing device 353, the CPU (drive control device) 354 and the memory 355 may constitute a disc drive (hereinafter referred to as a drive, as occasion demands). Moreover, the data input/output control device 306, the operation control device 307, the operation button 310, and the display panel 311 may constitute a host computer (hereinafter referred to as a host, as occasion demands). Alternatively, the CPU (drive control device) 354 and the bus 357 may constitute a communication device.

The spindle motor 351 is a device for rotating and stopping the optical disc 100, and is constructed to operate upon accessing the optical disc. More specifically, the spindle motor 351 is constructed to rotate and stop the optical disc 100 at a predetermined speed, under spindle servo from a not-illustrated servo unit or the like.

The optical pickup 352 is a device for performing the recording/reproduction with respect to the optical disc 100, and is provided with a laser device, a lens, and the like. More specifically, the optical pickup 352 irradiates the optical disc 100 with a light beam, such as a laser beam, as reading light with a first power upon reproduction, and as writing light with a second power upon recording, with it modulated.

The signal recording/reproducing device 353 controls the spindle motor 351 and the optical pickup 352, to thereby perform the recording/reproduction with respect to the optical disc 100. More specifically, the signal recording/reproducing device 353 is provided with: a laser diode (LD) driver; a head amplifier; and the like, for example. The laser diode driver (LD driver) drives a not-illustrated semiconductor laser device located in the optical pickup 352. The head amplifier amplifies the output signal of the optical pickup 352, i.e. the reflective light of a light beam, and outputs the amplified signal. More specifically, the signal recording/reproducing device 353 drives the not-illustrated semiconductor laser device located in the optical pickup 352, in order to determine an optimum laser power in the recording and reproduction processes for the OPC pattern, together with a not-illustrated timing generator or the like, under the CPU 354, upon the OPC (Optimum Power Calibration) process. Incidentally, the signal recording/reproducing device 353 constitutes one example of the “writing device” of the present invention, together with the optical pickup 352.

The memory 355 is used in the general data processing and the OPC process or the like on the recording/reproducing apparatus 300, including a buffer area for the record/reproduction data, an area used as an intermediate buffer when data is converted into the data that can be used on the signal recording/reproducing device 353, and the like. Moreover, the memory 355 is provided with: a ROM area into which a program for performing an operation as a recording device, i.e. firmware, is stored; a buffer used for compression/decompression of video data; a RAM area into which a parameter required for the operation of the program or the like is stored; and the like.

The CPU (drive control device) 354 is a device for controlling the entire recording/reproducing apparatus 300, and is connected to the signal recording/reproducing device 353 and the memory 355 through the bus 357, and is constructed to give an instruction to each controlling device. In general, software or firmware for operating the CPU 354 is stored in the memory 355. Incidentally, the CPU 354 constitutes one example of the “controlling device” of the present invention, together with the memory 355.

The data input/output control device 306 controls the input/output of the data from the exterior with respect to the recording/reproducing apparatus 300, to thereby perform storage to and export from the data buffer on the memory 355. If the input/output of the data is a video signal, the data input/output control device 306 compresses (encodes) the data received from the exterior in a MPEG format, for example, and outputs it to the memory 355, upon data inputting. Upon data outputting, it decompresses (decodes) the encoded data in the MPEG format or the like received from the memory 355, and outputs it to the exterior.

The operation control device 307 has a function of receiving an operation instruction to the recording/reproducing apparatus 300 and a function of transmitting display data onto the display panel 311. Specifically, it is constructed from a not-illustrated CPU and memory or the like, so as to transmit an instruction by the operation button 310, such as an instruction to record or reproduce, to the CPU 354, and to output the operation state of the recording/reproducing apparatus 300, such as during recording and during reproduction, to the display panel 311.

Such a recording/reproducing apparatus 300 is household-use recorder equipment for recording and reproducing video images. By executing a program stored in the memory 355, on the processor 354, the recording/reproducing apparatus 300 can perform the operation as the recorder equipment, i.e. recording a video signal from a broadcast reception tuner and an external connection terminal, onto a disc, and outputting the video signal reproduced from the disc to external display equipment, such as a television.

(Flow of Recording Operation performed by Information Recording Apparatus of Present Invention)

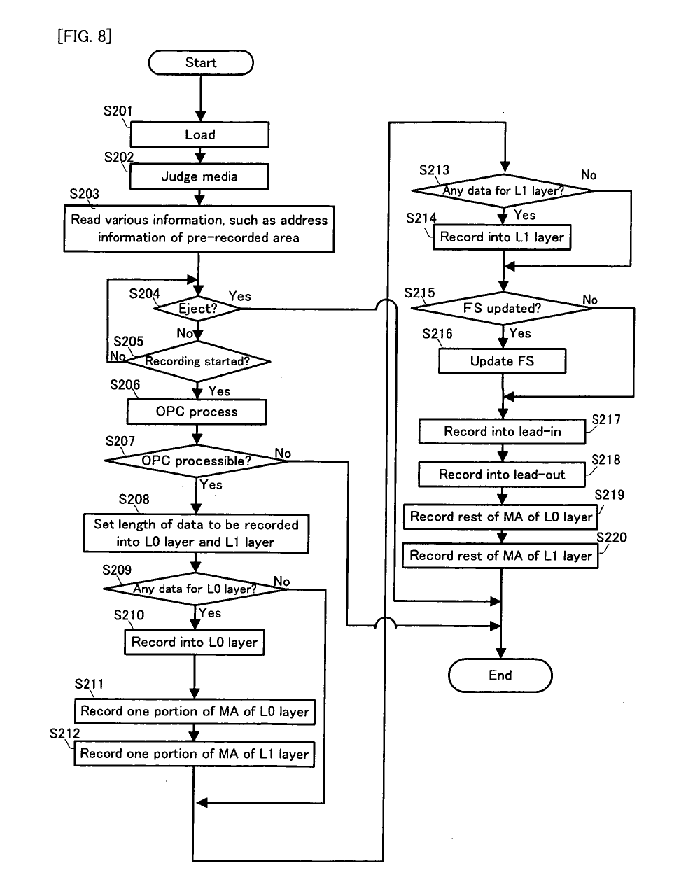

Next, with reference to FIG. 7 and FIG. 8, and the structure shown in FIG. 2 or FIG. 3, the recording operation onto the optical disc 100 performed by the recording/reproducing apparatus 300 will be explained. FIG. 8 shows a recording operation procedure with respect to the optical disc, performed by the recording/reproducing apparatus 300, as the embodiment of the information recording method of the present invention.

If the optical disc 100 is inserted (step S201), a seek operation is performed by the optical pickup 352 under the control of the CPU 354, and the type of the optical disc, such as a DVD-R or RW, is judged (step S202). More specifically, it is judged by using the value of “Book Type” in management information physically recorded in the control data zone, for example.

Subsequently, the various management information necessary for the recording process on the optical disc 100, is obtained (step S103). By virtue of the management information, the address information about a recorded area, the number of recording layers, and whether the recording layer is of an opposite track path type, of a parallel track path type, or a single layer, are distinguished or identified.

Incidentally, particularly here, by using the management information, whether or not the lead-out area is formed in advance, whether the pre-recorded area 105 is formed from embossed pits or pre-pits obtained by the irradiation of recording laser, and the start address and the end address of the pre-recorded area 105, are distinguished or identified. However, these kinds of identification information can be obtained in advance if the standard form of the optical disc 100 is determined, and may be stored in advance in the memory 355, separately from writing software, or as one portion thereof.

Then, it is judged whether or not the optical disc is ejected (step S204). Here, if it is not ejected (the step S204: No), moreover, it is judged whether or not an instruction to start the recording is given, on the drive (step S205). If the instruction to start the recording is given (the step S205: Yes), an OPC process of detecting an optimum recording laser power is performed (step S206). If the optimum recording laser power can be detected (the step S207: Yes), under the control of the CPU 354, the amount of information recorded into the L0 layer and the L1 layer is calculated, and a turn-around point in the L0 layer and a correspondence address in the L1 layer are calculated (step S208). At that time, a writing allowable value in the L1 layer is calculated on the basis of the address of the end edge of the writable area, i.e. the Last Recordable Address. This address can be determined from the start address of the pre-recorded area 105.

Then, it is judged whether or not there is information to be recorded into the L0 layer (step S209). If there is the information to be recorded into the L0 layer (the step S209: Yes), the data is written into the L0 layer by a sector unit or an ECC block unit, for example (step S210). Then, buffer data is added to one portion of the middle area 104 of the L0 layer. Moreover, after layer jump, buffer data is added as one portion of the middle area 104 of the L1 layer (step S212).

Then, it is judged whether or not there is information to be recorded into the L1 layer (step S213). If there is the information to be recorded into the L1 layer (the step S213: Yes), the writing is performed in the L1 layer by the sector unit or the ECC block unit, for example (step S214).

In the embodiment, as described above, the amount of data to be written into the L1 layer is set in advance on the basis of the Last Recordable Address, so that it is prevented to mistakenly write the data up to the pre-recorded area 105. Therefore, the data is properly recorded onto the optical disc 100.

After that, the normal process is performed. Firstly, it is judged whether or not the file system (FS) in the user data area 102 is to be updated (step S215), and if it is to be updated (the step S215: Yes), the file system is updated (the step S216).

Then, a finalize process is started, and the management information or the like is recorded into the lead-in area 101 (step S217), and buffer data is added into the lead-out area 103 (step S218). Then, buffer data is added to the remaining portion of the middle area 104 of the L0 layer (step S219). Then, after layer jump, buffer data is added to the remaining portion of the middle area 104 of the L1 layer (step S220).

Then, a series of sequential recording is ended.

### Second Embodiment

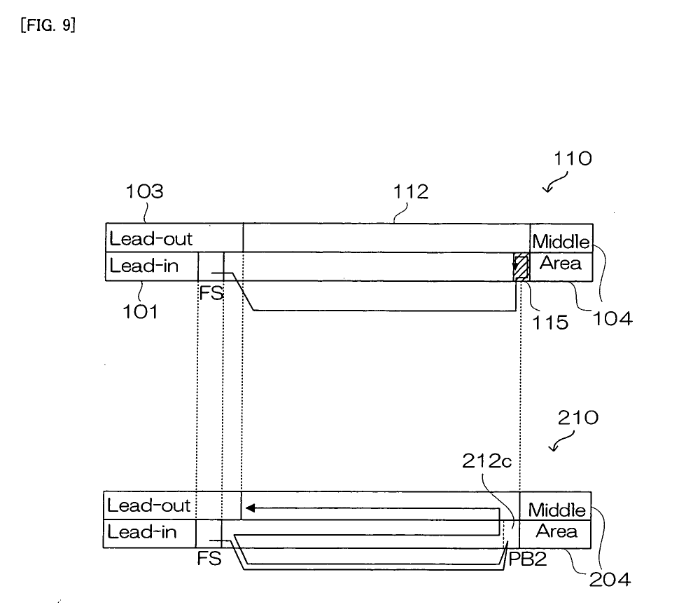

Next, the second embodiment of the present invention will be explained with reference to FIG. 9.

FIG. 9 corresponds to FIG. 2, showing the layout of the data area of an optical disc 110 in the second embodiment, located on the upper side of FIG. 9, and the layout of the data area of the ROM disc 200 corresponding to the optical disc 110, located on the lower side of FIG. 9. Incidentally, in the optical disc 110 in the embodiment, the same constituent elements as those of the optical disc 100 in the first embodiment carry the same numerical references, and the explanation thereof will be omitted.

In FIG. 9, the optical disc 110 has the same basic structure as that of the optical disc 100, but it is different from the optical disc 100 in that a pre-recorded area 115 is set on the end edge of the data area 112 of the L0 layer, i.e. in an area just before the middle area 104. The pre-recorded area 115 is provided between contents and contents, in terms of the data structure, however, in terms of the physical structure, it is provided on the end edge of one of the two layers. As in the first embodiment, the content data of the data area 112 is not divided by the pre-recorded area 115, which is convenient for the data management.

Such an optical disc 110 achieves the content protection function with respect to a ROM disc 210 shown in FIG. 9. Namely, on the ROM disc 210, video reproduction control information PB2 is recorded in a data area 212c corresponding to the pre-recorded area 115. Incidentally, due to such a structure, the reproduction operation is performed in a procedure shown in arrows in FIG. 9, on the optical disc 110 and the ROM disc 210.

The other effects and operations are the same as in the first embodiment.

The present invention has been explained by illustrating the embodiments, however, various changes may be made, other than the above mentioned embodiments, with respect to the information recording medium, the information recording apparatus and method, and the computer program of the present invention. For example, the first and second embodiments are designed such that the position and the range of the pre-recorded area completely correspond to the position and the range of the recording area where the video reproduction control information is recorded. However, it may be set such that the position and the range of the pre-recorded area include at least one portion of an area corresponding to the recording area where the video reproduction control information is recorded. In this case, the video reproduction control information can be obtained only in an imperfect condition, so that it is possible to prevent the reproduction of contents, in the same manner as the embodiments.

Alternatively, the first and second embodiments are designed such that the pre-recorded area is set just before the lead-out area; however, it may be just after the lead-in area. As can be seen from the above explanation, in principle, it is possible to achieve the purpose of the content protection, only by setting the pre-recorded area in accordance with the position and the range of the reproduction control information in the contents which are a protection target. However, if the pre-recorded area is set in the center of the data area, for example, it is necessary to consider the case where the record data is divided by the pre-recorded area, so that there is possibly a bad effect of complicated data management or the like. That is why, in the present invention, the pre-recorded area is set on the end edge of the data area.

Moreover, the term “non-overwritable” for the pre-recorded area of the information recording medium of the present invention includes not only the case where it cannot be written at all, but also the case where it is physical rewritten to the extent that the complete reproduction is impossible.

Moreover, in the information recording medium of the present invention, the lead-in area, the lead-out or middle area may be further segmentized. Moreover, in the case of the two-layer type optical disc, the parallel track path type may be adopted, as well as the above-mentioned opposite track path type, as the recording/reproducing method. Moreover, the information recording medium of the present invention is not limited to a two-layer single sided type, i.e., a dual layer type, but may be a two-layer double sided type, i.e., a dual layer double sided type. Furthermore, the recording layer is not limited to the two recording layers, as described above, but may be a single layer, or three or more layers.

In the above-mentioned embodiments, the optical disc, such as a two-layer type DVD-R or DVD-R/W, is explained as a specific example of the information recording medium of the present invention. The present invention, however, can be applied to other types of information recording media, for example, a large-capacity recording medium, such as a Blue-ray disc.

The present invention is not limited to the above-described embodiments, and various changes may be made, if desired, without departing from the essence or spirit of the invention which can be read from the claims and the entire specification. An information recording medium, an information recording apparatus, an information recording method, and a computer program, which involve such changes, are also intended to be within the technical scope of the present invention.

### INDUSTRIAL APPLICABILITY

The information recording medium, the information recording apparatus and method, and the computer program according to the present invention can be applied to a high-density recording medium, such as a DVD, and also applied to an information recording apparatus, such as a DVD recorder. Moreover, they can be applied to an information recording apparatus or the like, which is mounted on or can be connected to various computer equipment for consumer use or business use, for example.

1. An information recording medium comprising:
a user information recording area in which user information can be recorded,
said user information recording area having a pre-recorded area for preventing recording/reproduction of the user information, in an edge portion corresponding to a recording area portion in which reproduction control information for a read-only recording medium is recorded.

2. The information recording medium according to claim 1, wherein
said information recording medium further comprises:
a lead-in area ahead of said user information recording area; and
a lead-out area following said user information recording area, and
the edge portion is a portion adjacent to said lead-in area or said lead-out area.

3. The information recording medium according to claim 1, wherein embossed pits are formed in advance in the pre-recorded area.

4. The information recording medium according to claim 1, wherein pre-pits obtained by irradiation of recording laser are formed in advance in the pre-recorded area.

5. The information recording medium according to claim 1, wherein
said information recording medium comprises a plurality of recoding layers in each of which recording areas constituting one portion of said user information recording area are formed and which are mutually laminated, a start edge portion of said user information recording area is disposed in one recording layer so as to face an end edge portion of said user information recording area in another recording layer, and
the pre-recorded area is set in the end edge portion.

6. The information recording medium according to claim 1, wherein reproduction restriction information which functions to prevent reproduction of information which is recorded in said user information recording area, is written in the pre-recorded area.

7. The information recording medium according to claim 6, wherein the reproduction restriction information includes control information for making the information which is recorded in a predetermined area being loop-reproduced.

8. The information recording medium according to claim 1, wherein reproduction end information for ending reproduction of information which is recorded in said user information recording area by jumping to a reproduction end area defined in advance, is written in the pre-recorded area.

9. The information recording medium according to claim 1, wherein unreproducibility-announcing information for displaying a message indicating that reproduction of information which is recorded in said user information recording area is forbidden, is written in the pre-recorded area.

10. The information recording medium according to claim 1, wherein scan-forbidding information indicating that an instruction to scan information which is recorded in said user information recording area is set to be invalid in a reproduction period of the pre-recorded area and before the reproduction period, is written in at least one of the pre-recorded area and an area which is outside said user information recording area.

11. The information recording medium according to claim 1, wherein a start address and an end address of the pre-recorded area are fixed.

12. An information recording apparatus for recording information which is to be recorded onto an information recording medium comprising: a user information recording area in which user information can be recorded, said user information recording area having a pre-recorded area for preventing recording/reproduction of the user information, in an edge portion corresponding to a recording area portion in which reproduction control information for a read-only recording medium is recorded,
said information recording apparatus comprising:
a writing device capable of writing the information which is to be recorded, into said user information recording area; and
a controlling device for controlling said writing device to write the information which is to be recorded, into an area other than the pre-recorded area out of said user information recording area, on the basis of address information in the pre-recorded area.

13. An information recording method of recording information to be recorded onto an information recording medium comprising: a user information recording area in which user information can be recorded, said user information recording area having a pre-recorded area for preventing recording/reproduction of the user information, in an edge portion corresponding to a recording area portion in which reproduction control information for a read-only recording medium is recorded,
said information recording method comprising:
a writing process of writing the information to be recorded, into an area other than the pre-recorded area out of said user information recording area, on the basis of address information in the pre-recorded area.

14. A computer program product in a computer-readable medium for tangibly embodying a program of instructions executable by a computer provided in an information recording apparatus, the computer program product making the computer function as at least one portion of a controlling device and a writing device,
said information recording apparatus for recording information which is to be recorded onto an information recording medium comprising: a user information recording area in which user information can be recorded, said user information recording area having a pre-recorded area for preventing recording/reproduction of the user information, in an edge portion corresponding to a recording area portion in which reproduction control information for a read-only recording medium is recorded,
said information recording apparatus comprising:
said writing device capable of writing the information which is to be recorded, into said user information recording area; and
said controlling device for controlling said writing device to write the information which is to be recorded, into an area other than the pre-recorded area out of said user information recording area, on the basis of address information in the pre-recorded area.
